(19) United States
(12) Patent Application Publication
(10) Pub. No.: US 2026/0045035 A1
(43) Pub. Date: Feb. 12, 2026

(54) CREATING THREE-DIMENSIONAL OBJECT FROM TWO-DIMENSIONAL IMAGE

(71) Applicant: Google LLC, Mountain View, CA (US)

(72) Inventors: Ruofei Du, San Francisco, CA (US); Erzhen Hu, Charlottesville, VA (US)

(21) Appl. No.: 19/295,111

(22) Filed: Aug. 8, 2025

Related U.S. Application Data
(60) Provisional application No. 63/681,479, filed on Aug. 9, 2024.

(51) Int. Cl. G06T 17/00; G06T 15/08

(52) U.S. Cl. CPC G06T 17/00; G06T 15/08

(57) ABSTRACT

A method comprises selecting a two-dimensional image based on input to a computing device, generating multiple two-dimensional views of an object based on the two-dimensional image, and generating a three-dimensional virtual object based on the multiple two-dimensional views.

### CROSS-REFERENCE TO RELATED APPLICATION

This application claims priority to U.S. Provisional Patent Application No. 63/681,479, filed on Aug. 9, 2024, entitled, “TRANSFORMING CONTENT INTO INTERACTIVE OBJECTS FOR COMMUNICATION IN EXTENDED REALITY,” the disclosure of which is incorporated by reference herein in its entirety.

### BACKGROUND

Users can communicate with each other during video sessions, where they see images of each other or avatars representing the users and can communicate via voice. Users can also share images with each other during the video sessions.

### SUMMARY

A computing system can select a two-dimensional image based on input from a user. The two-dimensional image can be based on an image search prompted by text input from a user, be based on an image captured by a camera, or be based on hand movement such as a user sketching an image, as non-limiting examples. The computing system generates multiple two-dimensional views of an object based on the two-dimensional image. The computing system generates a three-dimensional virtual object based on the multiple two-dimensional views. In an example use case, a user can interact with the three-dimensional virtual object during a video session such as, for example, a videoconference. The computing system sends the three-dimensional virtual object to a remote computing device during the video session. A remote user can view and interact with the three-dimensional virtual object during the video session.

According to an example, a method comprises selecting a two-dimensional image based on input to a computing device, generating multiple two-dimensional views of an object based on the two-dimensional image, and generating a three-dimensional virtual object based on the multiple two-dimensional views.

According to an example, a non-transitory computer-readable storage medium comprises instructions stored thereon. When executed by at least one processor, the instructions are configured to cause a computing system to select a two-dimensional image based on input to a computing device, generate multiple two-dimensional views of an object based on the two-dimensional image, and generate a three-dimensional virtual object based on the multiple two-dimensional views.

According to an example, a computing system comprises at least one processor and a non-transitory computer-readable storage medium comprising instructions stored thereon. When executed by the at least one processor, the instructions are configured to cause the computing system to select a two-dimensional image based on input to a computing device, generate multiple two-dimensional views of an object based on the two-dimensional image, and generate a three-dimensional virtual object based on the multiple two-dimensional views.

The details of one or more implementations are set forth in the accompanying drawings and the description below. Other features will be apparent from the description and drawings, and from the claims.

### BRIEF DESCRIPTION OF THE DRAWINGS

FIG. 1 shows generation of a three-dimensional virtual object during a video session between a local user and a remote user.

FIG. 2A shows a two-dimensional image.

FIG. 2B shows multiple views of an object generated based on the two-dimensional image of FIG. 2A.

FIG. 2C shows a three-dimensional virtual object generated based on the multiple views of FIG. 2B.

FIG. 3 shows a pipeline of input methods and resulting data representations.

FIGS. 4A through 4D show a sequence of events from selection of an image to representation of a three-dimensional virtual object.

FIGS. 5A and 5B show a third-person perspective and a first-person perspective of an object and an interactive version of the object.

FIG. 6 is a block diagram of a computing system.

FIG. 7 is a flowchart of a method performed by the computing system.

Like reference numbers refer to like objects.

### DETAILED DESCRIPTION

Users, who can include a local user interacting with a local computing device and a remote user interacting with a remote computing device, can communicate with each other, as well as other users, during a video session. During the video session, live images of the users, or avatar representations of the users, are sent between the local computing device and the remote computing device. Audio data, such as voice data, are also sent between the computing devices. The images and audio data facilitate an immersive virtual environment within the video session, creating an impression of the users being in the presence of each other. Shared content, such as physical objects within the environment of either user, documents such as product designs or digital assets, or electronic images, can facilitate communication and idea generation.

A technical problem with video sessions that include two-dimensional representations of shared content is the difficulty of users viewing and interacting with the shared content. A two-dimensional representation limits views (or perspectives) of the shared content to the single view, despite the users being in different positions within a virtual environment. The two-dimensional representation also limits the ability of the users to interact with or manipulate the shared content. In physical in-person meetings, by contrast, participants can easily rotate, manipulate, and interact with content.

A technical solution to this technical problem is for a computing system to generate a three-dimensional virtual object based on the shared content. The three-dimensional virtual object can be shared with, and/or presented to, both (or all) users within the video session. The users can interact with the three-dimensional virtual object, such as by pushing or rotating the three-dimensional object. The users can view changes to the location and orientation of the three-dimensional virtual object caused by interactions by themselves or other users, creating a realistic, immersive environment that simulates the users being in a same physical location with a physical object to interact with. Generating the three-dimensional virtual object based on the shared content includes selecting a two-dimensional image corresponding to the shared content, generating multiple two-dimensional views of an object based on the two-dimensional image, and generating the three-dimensional virtual object based on the multiple two-dimensional views.

The computing system can rotate and otherwise modify a representation of the three-dimensional virtual object based on positions of the users in the virtual environment with respect to the three-dimensional virtual object, and based on interactions with the three-dimensional virtual object by the users. This technical solution has the technical benefits of generating a realistic representation of the virtual object within the virtual environment and enhancing discussions between users about the shared content. The three-dimensional virtual object is generated based on a selection of the user. The three-dimensional virtual object can be generated during the video session, without preparation of three-dimensional virtual objects before the video session. The users can interact with the three-dimensional virtual object, such as by moving or rotating the object. The interactions result in movements and/or rotations of the three-dimensional virtual object that can be viewed both by users who interacted with the three-dimensional virtual object and other users. If one user pushes the three-dimensional virtual object toward another user so that the three-dimensional virtual object becomes close to the other user, then the other user can interact with the three-dimensional virtual object. In the context of the video session, the video session may be a real-time, visual communication link between two or more people in separate locations. The generation of a three-dimensional object based on a two-dimensional image can also be applied in contexts with a single user, such as a user playing an immersive video game or generating objects for production within an additive manufacturing process or inclusion within engineering drawings.

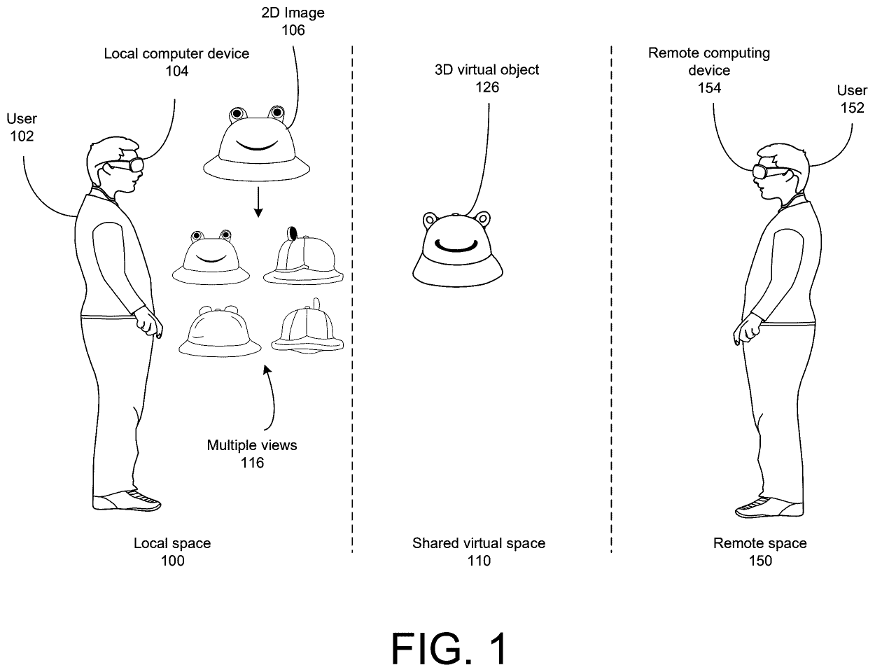

FIG. 1 shows generation of a three-dimensional virtual object 126 during a video session between a local user 102 and a remote user 152. A video session can be considered a live event in which video output and audio output are presented to a remote user via a remote computing device based on video input and audio input of a local user captured by a local computing device and video output and audio output are presented to the local user via the local computing device based on video input and audio input of the remote user captured by the remote computing device. The local user 102 interacts with a local computing device 104 within a local space 100. The local computing device 104 can be a computing system with at least one camera for capturing images of the local user 102, at least one microphone for capturing audio signals such as voice signals from the local user 102, at least one speaker for outputting sound during the video session, and at least one display for presenting images to the local user 102 during the video session. In some implementations, the local computing device 104 includes two displays, one display for each eye of the local user 102, to create a stereoscopic effect with three-dimensional images within an immersive environment. The at least one camera included in the local computing device 104 can include a depth camera, such as a time-of-flight depth camera, aligned with a view of the local user 102 to capture a physical scene in front of the local user 102. The capture of the physical scene enables a computing system to capture the physical scene and generate three-dimensional objects based on two-dimensional images captured by the camera. As described herein, a computing system that generates a three-dimensional virtual object can include the local computing device 104 and/or one or more computing devices in communication with the local computing device 104. The local space 100 can be a physical environment that the local user 102 is located in, such as an office or other room. A video session is an example use case of generating a three-dimensional virtual object based on a two-dimensional image. Other example use cases are generating a three-dimensional virtual object during an immersive video game or generating a three-dimensional virtual object for production within an additive manufacturing process or inclusion within an engineering drawing.

The remote user 152 can be located in a remote space 150, a physical location that is remote from the local user 102. The remote user 152 can interact with a remote computing device 154 that has similar features as the local computing device 104. In some implementations, the local computing device 104 communicates with the remote computing device 154 via a server that facilitates and/or hosts the video session. The remote computing device 154 can be considered an other computing device.

The computing system can share the three-dimensional virtual object 126 in the video session between the local computing device 104 and the remote computing device 154. The sharing of the three-dimensional virtual object 126 in the video session enables interaction with the three-dimensional virtual object 126 by the local computing device 104 based on input to the local computing device 104 from the local user 102. The sharing of the three-dimensional virtual object 126 in the video session enables interaction with the three-dimensional virtual object 126 by the remote computing device 154 based on input to the remote computing device 154 from the remote user 152. The interactions with the three-dimensional virtual object 126 by the local computing device 104 and/or remote computing device 154 modify attributes of the three-dimensional virtual object 126 such as location, orientation, size, and/or shape. The modified attributes of the three-dimensional virtual object 126 can be viewed by both the local user 102 via the local computing device 104 and the remote user 152 vis the remote computing device 154.

The local computing device 104 can select a two-dimensional image 106. The local computing device 104 can select the two-dimensional image 106 based on input from the local user 102. The two-dimensional image 106 can be based on a physical object in contact or proximity with the local user 102, or an electronic object or image accessed or generated by the computing system.

In some implementations, the input from the local user 102 includes text input from the local user 102. Text input can include text typed into a human interface device (HID) such as a keyboard included in or in communication with the local computing device 104, text interpreted from gestures captured by a camera included in or in communication with the local computing device 104, or text transcribed or recognized based on audible speech captured by a microphone included in or in communication with the local computing device 104. In some implementations, the computing system performs an image search based on the text input. In some implementations, the computing system performs the image search by searching a database based on the text input by applying semantic analysis of the text input. In some implementations, the local computing device 104 or computing system performs the image search by providing the text input to a search engine as query terms and selecting an image returned by the search engine.

In some implementations, the two-dimensional image 106 is captured by a camera included in or in communication with the local computing device 104. The input from the local user 102 can include a gesture, such as by a portion of a hand of the local user 102 including a finger such as an index finger of the local user 102. The gesture can indicate a portion of the image captured by the camera. In some implementations, the image captured by the camera is presented to the local user 102 by a display included in the local computing device 104 as part of a virtual reality experience. In some implementations, the local user 102 sees the object captured as the two-dimensional image 106 as part of the physical environment within the local space 100 as part of an augmented reality environment. The two-dimensional image 106 can be a portion of the image captured by the camera. The local user 102 can indicate the two-dimensional image 106 by pointing to, or gesturing around, an object included in an image captured by the camera. The computing system can detect an object that becomes the two-dimensional image 106 by an object detection technique, such as a non-neural approach including Viola-Jones detection, scale-invariant feature transform (SIFT), histogram of oriented gradients (HOG), or neural network approaches such as OverFeat, region Proposals, Single Shot MultiBox Detector (SSD), Single-Shot Refinement Neural Network for Object detection (RefineDet), or deformable convolutional networks, as non-limiting examples. In some implementations, the local computing device 104 presents the two-dimensional image 106 selected from the image captured by the camera to the local user 102 as a proposed image for generating a three-dimensional virtual object. The local user 102 can confirm selection of the two-dimensional image 106, such as by an audible voice instruction, a hand gesture, or a head gesture, as non-limiting examples.

In some implementations, the computing system converts an image selected from an image search or captured by a camera into a two-dimensional segmented image. The computing system can resize and/or scale the image to a particular size, filter the image (such as by applying a Gaussian blur filter) to remove random noise that can interfere with boundary detection, and/or convert a color space of the image, such as between color (e.g. RGB) and grayscale. The computing system can segment the image by dividing the image into regions, such as by thresholding (e.g. global thresholding or adaptive thresholding), a clustering-based method such as k-means clustering that groups pixels into ‘k’ clusters based on color and/or intensity values of the pixels, an edge-based segmentation method such as canny edge detection that identifies sharp changes in intensity that correspond to boundaries of the object, or semantic segmentation using neural networks that generate pixel-wise classification and assigns each pixel to a class label. After the segmentation, the computing system can perform morphological operations to refine the image such as erosions to remove islands of pixels and shrink the boundaries of objects, dilation to expand boundaries of objects, and/or labeling and analysis to determine an area, perimeter, and/or shape of the object.

In some implementations, the computing system generates the two-dimensional segmented image by extracting key points of the two-dimensional image 106. The computing system can extract the key points based on continuous marking gestures. The continuous marking gestures can be based on gestures of the local user 102 and/or movements of a controller held by the local user 102 made with respect to the object based on which the two-dimensional image 106 was generated. The computing system can request the local user 102 to confirm the generated two-dimensional segmented image, and generate the multiple views 116 in response to confirmation or approval input from the local user 102. If the local user 102 does not confirm or approve the two-dimensional segmented image, then the computing system can generate another two-dimensional segmented image based on the two-dimensional image 106.

In some implementations, the input from the local user 102 includes hand movement by the local user 102. The hand movement by the local user 102 can be captured by a camera included in or in communication with the local computing device 104. The computing system can interpret the hand movement as gestures and/or a sketch. The computing system can, for example, process the hand movement as input to a generative model that generates the two-dimensional image 106 based on the hand gesture. The computing system can receive the two-dimensional image 106 from the generative model. In some implementations, the computing system presents the two-dimensional image 106 provided by the generative model to the local user 102 as a proposed image for generating a three-dimensional virtual object. The local user 102 can confirm selection of the two-dimensional image 106, such as by an audible voice instruction, a hand gesture, or a head gesture, as non-limiting examples.

After selecting the two-dimensional image 106, the computing system generates multiple views 116 of an object based on the two-dimensional image 106. The multiple views 116 or two-dimensional views of the object from different perspectives. In some implementations, the different perspectives of the object are orthogonal to each other. In an example with four orthogonal perspectives, the perspectives can be from the front, matching the perspective of the original two-dimensional image 106, back or behind the object (from the perspective of the original two-dimensional image 106), from the left of the object (from the perspective of the original two-dimensional image 106), and from the right of the object (from the perspective of the original two-dimensional image 106). The multiple views 116 form a wraparound view of the object that is the subject of the two-dimensional image 106.

In some implementations, the multiple views 116 are represented by point clouds such as sparse point clouds. The point clouds representing each of the multiple views 116 can include a discrete set of data points in space. The points can be represented spatially by values for a set of coordinates, such as Cartesian coordinates (e.g. X, Y, and Z values). The points can be represented by color values, such as RGB (red, green, blue) color values. In some implementations, the local computing device 104 or computing system in communication with the local computing device 104 generates a first view of the multiple views 116 that corresponds to a perspective of the two-dimensional image 106 as a point cloud based on the two-dimensional image 106 before generating the other views of the multiple views. The computing system can generate the point clouds for the views of the multiple views 116 other than the view that corresponds to the perspective of the two-dimensional image 106 based on the point cloud for the view that corresponds to the perspective of the two-dimensional image 106.

In some implementations, the computing system generates the multiple views 116 by processing the two-dimensional image 106 with one or more multi-view diffusion models to generate the multiple views 116. The one or more multi-view diffusion models receive as input the single two-dimensional image 106, with desired output goals, such as four orthogonal azimuthal images (e.g. front view, right view, back view, and left view). The one or more multi-view diffusion models can add noise to the two-dimensional image 106 and denoise the resulting image from different viewpoints. During the denoising process, an attention mechanism applies cross-view attention to share information and maintain consistency between different views, such as maintaining edges or other salient features across different views to maintain consistency across the different views. The one or more multi-view diffusion models can simultaneously denoise a set of noisy latent representations, with one noisy latent representation for each desired output view (e.g. one noisy latent representation for each of the front view, right view, rear view, and left view). The two-dimensional image 106 serves as a condition for each of the desired output views to ensure that the output views are views of the same object. The one or more multi-view diffusion processes can denoise the latent representations by an iterative process, progressively removing noise from the latent representation while maintaining consistency across the latent representation that represents different views of the object. The multiple views 116 will be geometrically consistent with each other and the original input image, the two-dimensional image 106.

The computing system generates the three-dimensional virtual object 126 based on the multiple views 116. In some implementations, the computing system generates the three-dimensional virtual object 126 based on sparse point clouds that represent the multiple views 116. In some implementations, the computing system generates the three-dimensional virtual object 126 by performing Gaussian splatting based on the multiple views 116. The three-dimensional virtual object 126 can be represented as a three-dimensional point cloud. The three-dimensional virtual object 126 can be presented to both users 102, 152 within a shared virtual space by their respective computing devices 104, 154. Interactions with, and/or input to, the three-dimensional virtual object 126 by the local user 102 will be seen by the remote user 152, and interactions with, and/or input to, the three-dimensional virtual object 126 by the remote user 152 will be seen by the local user 102.

In some implementations, the computing system fuses the multiple views 116 into the three-dimensional virtual object 126 as a three-dimensional Gaussian representation. The computing system can the multiple views 116 into the three-dimensional virtual object 126 as a three-dimensional Gaussian representation by performing three-dimensional Gaussian splatting. The computing system can perform the three-dimensional Gaussian splatting by applying a set of multiple discrete, overlapping three-dimensional Gaussians. The three-dimensional Gaussians can be primitives that include a number of parameters such as position (e.g. coordinates such as x, y, and z values), a covariance matrix (e.g. a 3×3 matrix that defines a shape, size, and orientation of an ellipsoid), opacity (e.g. a value between zero and one that determines how transparent the Gaussian is), and/or spherical harmonics coefficients (e.g. a set of coefficients that describes the color of the Gaussian from different directions, allowing for realistic light and reflections). The computing system can generate the three-dimensional virtual object 126 by implementing a multi-stage process that includes initial sparse point cloud generation, initialization of the three-dimensional Gaussians, optimization and differential rendering, adaptive density control, and refinement.

The initial sparse point cloud generation can include performing Structure-from-Motion (SfM) techniques on the multiple views 116. SfM can analyze the multiple views 116 to find corresponding points across different views and use the corresponding points to triangulate three-dimensional positions of the corresponding points and estimate the camera poses for each of the multiple views 116, generating a sparse point cloud of the scene. Initialization of the three-dimensional Gaussians can include initializing the three-dimensional Gaussians based on the sparse points from the SfM output. Each point in the cloud can become the center of a new Gaussian. The initial parameters of the three-dimensional Gaussians can be set based on the SfM data, such as position based on the three-dimensional coordinates of the SfM point, covariance set as a small isotropic (spherical) Gaussian, with size related to distance to nearest neighbors, color sampled from the color of the pixel in the input images that corresponds to the SfM point, and a default opacity. Optimization and differentiable rendering can optimize the parameters of the three-dimensional Gaussians to match the input multi-view images, applying an iterative process that relies on differentiable rendering. Differential rendering can include rendering the current set of three-dimensional Gaussians from the viewpoint of one of the input images using a differentiable renderer to compute the gradient of the rendering process, comparing the rendered image to the corresponding ground-truth two-dimensional image from the diffusion model output using a loss function to measure the difference between the two images, and backpropagating the gradients from the loss function through the differentiable renderer to update the parameters of the three-dimensional Gaussians. The optimization adjusts the position, size, orientation, opacity, and spherical harmonic (SH) coefficients of each Gaussian to minimize the error. The adaptive density control adaptively controls the density of Gaussians to better represent the scene. Adaptive density control can implement an optimization loop that includes densification, such as adding new Gaussians in regions where the error is high or the gradients are large, to better capture the fine details by “cloning” existing Gaussians and moving the copy slightly or by “splitting” a large Gaussian into multiple smaller ones, and pruning by removing Gaussians that are too transparent (e.g. opacity at or below an opacity threshold) or contribute little to the final rendered image. Refinement can include a coarse-to-fine strategy where the learning rates for different parameters are adjusted over time.

The three-dimensional virtual object 126 is viewable by both the local user 102 and the remote user 152 within a virtual space 110. The three-dimensional virtual object 126 has a location and orientation within the virtual space 110. In some implementations, the computing system modifies the size and/or orientation of the three-dimensional virtual object 126 based on input from the local user 102. The three-dimensional virtual object 126 enables continuous changes of orientation from any perspective.

The computing system sends attributes of the three-dimensional virtual object 126 to the local computing device 104 and the remote computing device 154. The attributes can include size, shape, and/or color(s) of the three-dimensional virtual object 126, as well as location and/or orientation of the three-dimensional virtual object 126. The computing system can update the local computing device 104 and remote computing device 154 with changes to the three-dimensional virtual object 126, such as changes to the location and/or orientation of the three-dimensional virtual object 126. The local computing device 104 can present the three-dimensional virtual object 126 to the local user 102 via display(s) included in the local computing device 104. The local computing device 104 can present the three-dimensional virtual object 126 to the local user 102 based on the attributes of the three-dimensional virtual object 126 and the relative position of the three-dimensional virtual object 126 within the virtual space 110 and the position of the local user 102 within the local space 100. The local computing device 104 can present, and/or change the presentation of, the three-dimensional virtual object 126 based on the updated attributes of the three-dimensional virtual object 126. The remote computing device 154 can present the three-dimensional virtual object 126 to the remote user 152 in a similar manner that the local computing device 104 presents the three-dimensional virtual object 126 to the local user 102, taking into account the different relative position of the remote user 152 with respect to the three-dimensional virtual object 126 in the virtual space 110.

The local user 102 can, for example, move the three-dimensional virtual object 126 such as by rotating, pushing, or pulling the three-dimensional virtual object 126. The computing system can update the attributes of the three-dimensional virtual object 126, such as the location and/or orientation of the three-dimensional virtual object 126 within the virtual space 110, in response to the movement of the three-dimensional virtual object 126 by the local user 102. The movement of the three-dimensional virtual object 126 by the local user 102 can be based on movement input associated with the three-dimensional virtual object 126 received from the local user 102. The computing system can receive the movement input from the local user 102. The movement input can be movement by a hand or other portion of the local user 102, or movement of a controller or other input device. The movement can be associated with the three-dimensional virtual object 126 based on a location of the portion of the local user 102 or input device being at, or directed toward, the three-dimensional virtual object 126. The computing system will send the updated attributes to the local computing device 104 and the remote computing device 154. The local computing device 104 and remote computing device 154 can modify the respective presentations of the three-dimensional virtual object 126 to the local user 102 and the remote user 152 based on the updated attributes.

While FIG. 1 shows generation of a single three-dimensional virtual object 126 based on a single two-dimensional image 106, this is merely an example. The computing system can generate multiple three-dimensional virtual objects based on one or multiple different two-dimensional images, with multiple views of each object being generated, as described above. The multiple three-dimensional virtual objects can move in response to input from the users 102, 152 (or single user in use cases with only a single user). The multiple three-dimensional virtual objects can also move in response to interactions with each other, such as a first three-dimensional virtual object colliding with and bouncing off of a second virtual object. For example, the computing system could generate a three-dimensional virtual billiards table, three-dimensional billiards balls, and a three-dimensional virtual cue stick, based on two-dimensional image. One or multiple users could play a game of billiards by interacting with a virtual cue stick, which strikes a virtual cue ball and causes the virtual billiards balls to collide with and bounce off of each other and virtual walls of the virtual billiards table until one or more of the virtual billiards balls fall into virtual pickets of the virtual billiards table. The virtual objects can be generated based on instruction and/or selection of two-dimensional images by a single user, or instruction and selection by multiple users.

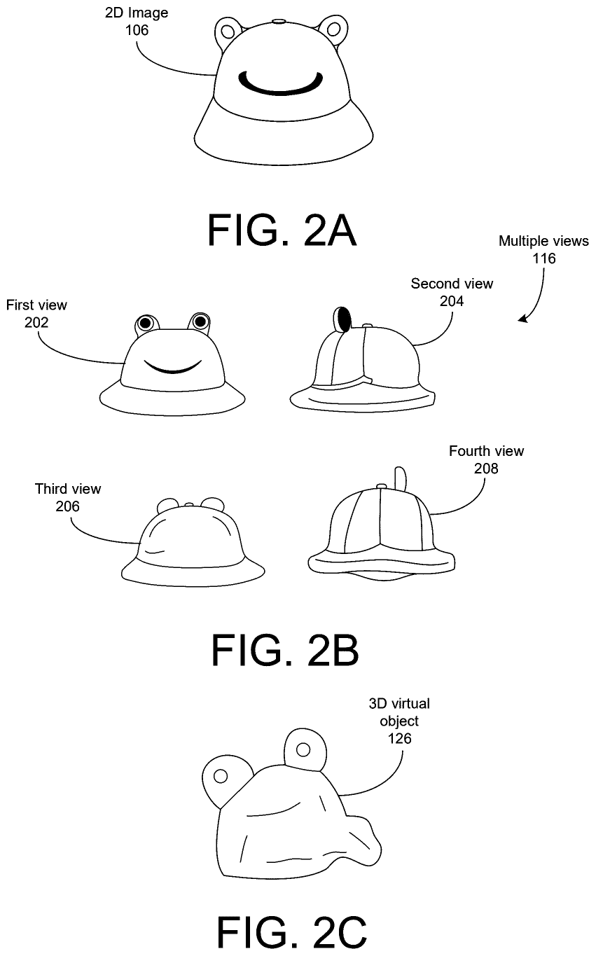

FIGS. 2A through 2C show data formats used by the computing system in generation of a three-dimensional virtual object. FIG. 2A shows the two-dimensional image 106. In the example shown in FIG. 2A, the two-dimensional image 106 is a face of a frog. The two-dimensional image 106 was selected by the computing system based on input from the local user 102. In some implementations, the local user 102 selects an object from a two-dimensional interface, such as a web browser, and the computing system converts the selected object into a segmented two-dimensional image. The input from the local user 102 indicated that the local user 102 desired to generate a three-dimensional virtual object (such as the three-dimensional virtual object 126) based on the two-dimensional image 106. The input from the local user 102 may have been text prompting an image search, a gesture or voice selection of an object captured by a camera included in the local computing device 104, or a drawing generated by the computing system based on one or more gestures of the local user 102 captured by the camera included in the local computing device 104. In an implementation in which the two-dimensional image 106 is included in an image captured by a camera included in the local computing device 104, the computing system can capture more than one two-dimensional image of the object, with the two-dimensional images capturing different views or perspectives of the same physical object. The two-dimensional image 106 can be represented and/or stored by the computing system in any image file format, such as Joint Photographic Experts Group (JPEG), Portable Network Graphics (PNG), or Graphics Interchange Format (GIF), as non-limiting examples.

FIG. 2B shows multiple views 116 of an object generated based on the two-dimensional image 106 of FIG. 2A. The multiple views 116 show the object from different perspectives or views. The multiple views 116 can be orthogonal to each other, such as sequentially rotating the object ninety degrees (90°) to generate four views that view the object from the front, right, back, and left. This is merely an example. Six orthogonal views could also be generated, to generate views that view the object from the front, right, back, left, top, and bottom. Another example would be four views with one hundred twenty degrees (120°) of rotation to view portions of the object from different perspectives. More views can result in greater precision in generating the three-dimensional virtual object 126, while consuming more computing resources.

A first view 202 of the multiple views 116 can have a same view or perspective of the object as the two-dimensional image 106. In the example shown in FIG. 2B, the first view 202 is a front view of a face of a frog, similar to the two-dimensional image 106. The first view 202 can be represented as a point cloud, with points representing locations on a surface of the object represented by the first view 202. The computing system can generate the first view 202 based on the two-dimensional image 106. The computing system can generate a second view 204 of the multiple views 116 based on the first view 202. The second view 204 can also be represented as a point cloud. The computing system can generate a third view 206 of the multiple views 116 based on the first view 202 and/or the second view 204. The third view 206 can also be represented as a point cloud. The computing system can generate a fourth view 208 of the multiple views 116 based on the first view 202, the second view 204, and/or the third view 206. The fourth view 208 can also be represented as a point cloud. In implementations in which a camera captured more than one two-dimensional image 106 of the same object, more than one of the multiple views 116 can be generated based on the two-dimensional image 106. In some implementations, after the computing system generates the three-dimensional virtual object 126 that was based on a physical object, the computing system captures additional images of the physical object from different perspectives and updates the spatial characteristics (such as size and/or shape) of the three-dimensional virtual object 126.

FIG. 2C shows the three-dimensional virtual object 126 generated based on the multiple views 116 of FIG. 2B. The computing system can generate the three-dimensional virtual object 126 based on the multiple views 116. The three-dimensional virtual object 126 can be represented as a point cloud. The three-dimensional virtual object 126 can include points for all surfaces of the virtual object, enabling the computing system, local computing device 104, and/or remote computing device 154 to generate two-dimensional images of the virtual object from any perspective.

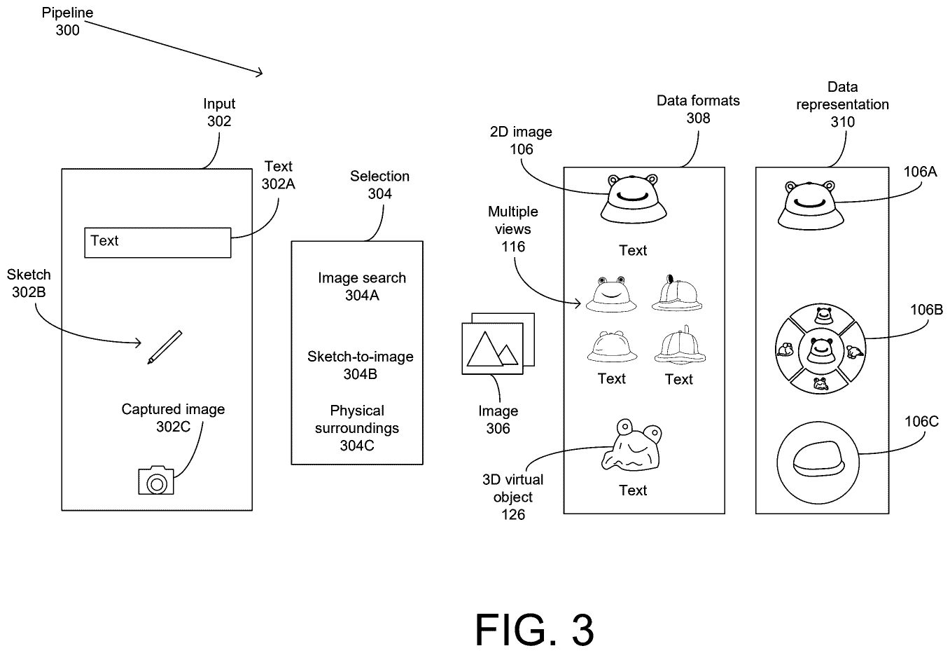

FIG. 3 shows a pipeline 300 of input methods and resulting data representations. The pipeline 300 shows how various forms of input from a user, such as the local user 102, result in data representations of virtual objects.

The pipeline 300 includes input 302. The input 302 can be received from a user, such as the local user 102. Examples of input 302 received from a user are text 302A, sketch 302B, and/or a captured image 302C. The text 302A can be received via a human interface device (HID) such as a keyboard, via interpreted gestures, or transcribed from audio speech of the user, as non-limiting examples. In the example shown in FIG. 3, the text 302A is, “Frog bucket hat.” The sketch 302B can be generated based on gestures of the user that are received and/or interpreted by the computing system. The captured image 302C can be an image or portion of an image captured by the computing system and selected by the user. The user can select the image or portion of the image by voice command, gesture command, or typed command, as non-limiting examples.

The computing system can perform selection 304 of an image, such as the two-dimensional image 106, based on the input 302. Examples shown in FIG. 3 include an image search 304A, sketch-to-image 304B, and physical surroundings 304C. The computing system can perform the image search 304A based on text 302A received from the user. In some implementations, the image search 304A is based on an image database accessible to the computing system using the text 302A as a query. In some implementations, the image search 304A includes submitting an image query to a search engine with the text 302A as search terms for the query and using one or more results returned by the search engine. The sketch-to-image 304B can include leveraging a model such as a generative model to generate an image based on the sketch 302B. The physical surroundings can be the subject of the captured image 302C.

The selection 304 based on the input 302 results in an image 306. The image can be a two-dimensional image. The image 306 can have properties of the two-dimensional image 106.

The computing system outputs a three-dimensional virtual object based on the image 306 by transforming the data format of the image 306. The data formats 308 into which the image 306 can be transformed include the two-dimensional image 106, the multiple views 116, and the three-dimensional virtual object 126. The first data format is the two-dimensional image 106. The computing system transforms the two-dimensional image 106 into the multiple views 116. The computing system transforms the multiple views 116 into the three-dimensional virtual object 126.

The computing system can store and/or present the three-dimensional virtual object 126 in any of multiple forms of data representation 310. In some implementations, the computing system stores the three-dimensional virtual object 126 as a segmented image 106A. In some implementations, the computing system stores the three-dimensional virtual object 126 as a conditioned multiview rendering 106B. In some implementations, the computing system stores the three-dimensional virtual object 126 as a three-dimensional Gaussian 106C, such as a radiance field rendering.

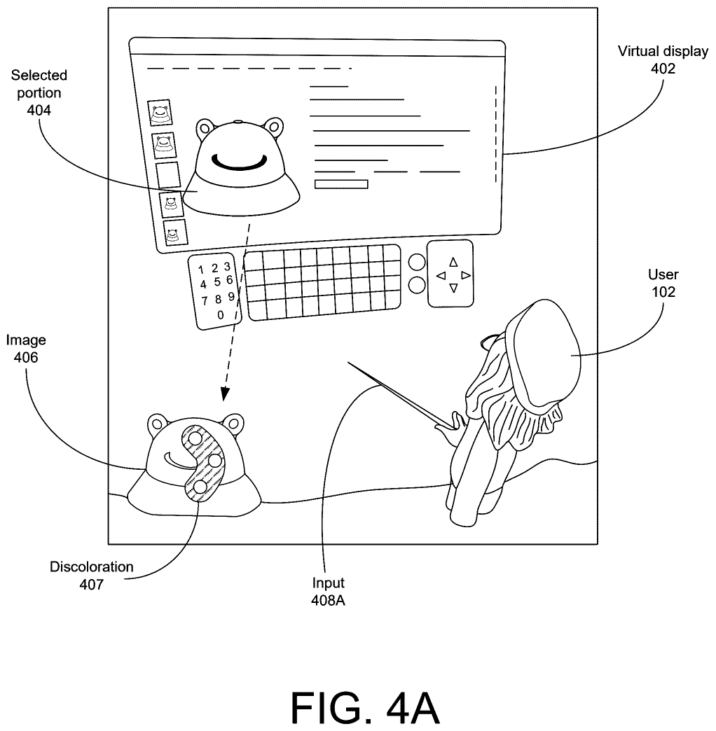

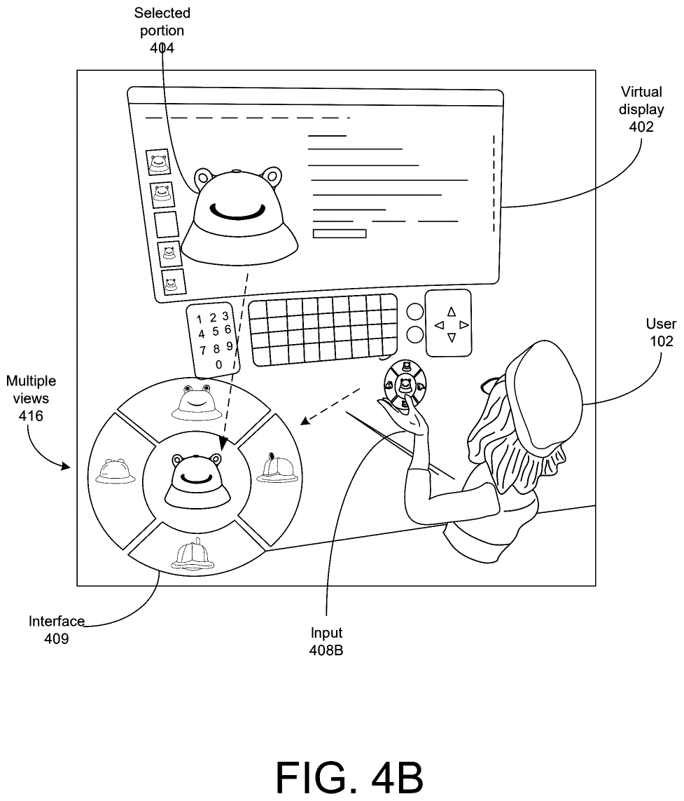

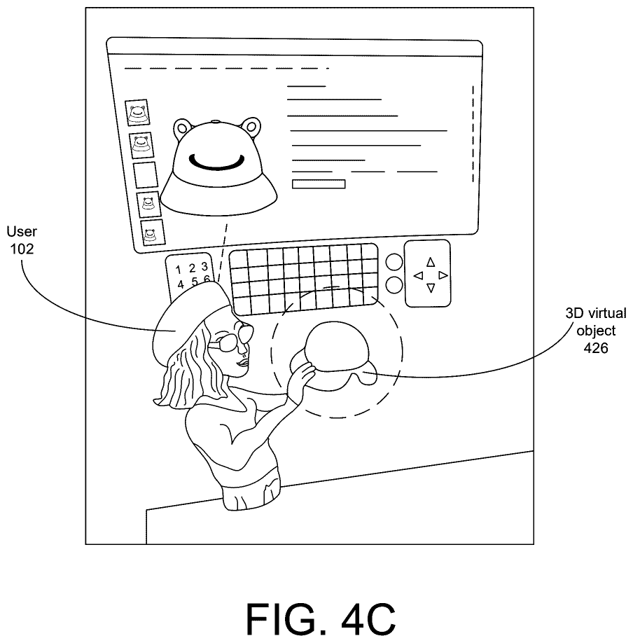

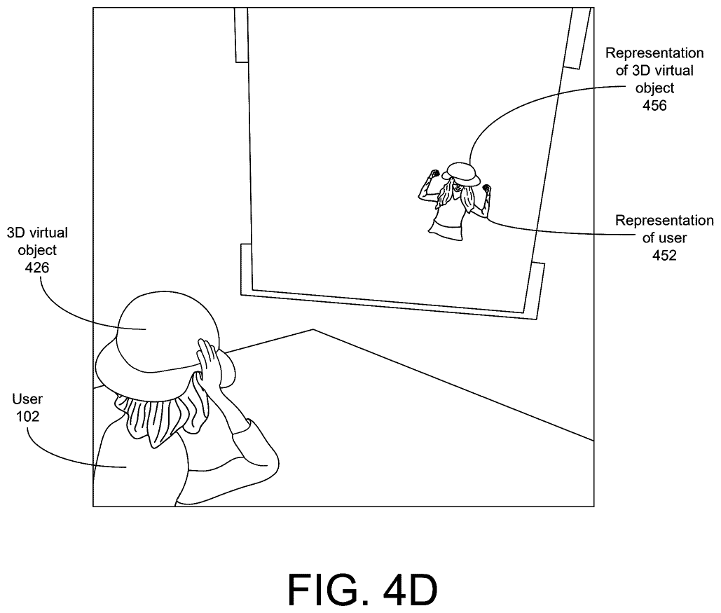

FIGS. 4A through 4D show a sequence of events from selection of an image to representation of a three-dimensional virtual object. FIG. 4A shows the local user 102 viewing a virtual display 402. The local user 102 can view the virtual display 402 via the local computing device 104 (not shown in FIG. 4A). The virtual display 402 can be presented to the local user 102 via one or more displays included in the local computing device 104.

The local user 102 provides input 408A. In the example shown in FIG. 4A, the input 408A is the local user 102 pointing, such as with a physical or virtual pointing device or body part such as a finger, to a selected portion 404 of the virtual display 402. In an implementation in which the local user 102 holds a controller with a button that is included in and/or in communication with the computing system, the local user 102 points toward the selected portion 404 with the controller and presses the button to indicate selection of the selected portion 404. In some implementations, the local user 102 points to multiple locations on the virtual display 402, forming a shape that overlays the selected portion 404. In some implementations, the local user 102 paints on the selected portion 404 by gesturing toward the selected portion 404. The computing system can determine the selected portion 404 based on a combination of gesture interpretation of images captured by a camera included in the computing system and object detection within the virtual display 402. The computing system can generate an image 406 based on the selected portion 404. The computing system can generate the image 406 as a two-dimensional segmented image by converting the selected portion 404 into a two-dimensional segmented image, as described above with respect to FIG. 1. The painting by the local user 102 on the selected portion 404 is shown by the discoloration 407 on the image 406. The image 406 can have similar features as the two-dimensional image 106. The local user 102 can confirm the selection of the image 406, such as by voice or audio input, gesture input, or input into the controller, as non-limiting examples.

FIG. 4B shows multiple views 416 of the image 406 presented to the local user 102. The multiple views 416 can have similar features as the multiple views 116. The multiple views 416 can be included in an interface 409. In the example shown in FIG. 4B, the interface 409 is a pie menu. The pie menu includes four portions or tiles that each include one of the multiple views 416 (front view, right view, back view, and rear view). The pie menu also includes a representation of the selected portion 404 in a center of the pie menu as the original image from which the multiple views 416 are generated. The user 102 can select one of the multiple views 416 by input 408B into the interface 409 by selecting one of the portions and/or rotating the pie menu until a desired view is shown in a predetermined (e.g. top) portion of the pie menu. The computing system can respond to selection of one of the multiple views 416 by presenting a three-dimensional virtual object to the local user 102 with the orientation selected by the local user 102. The computing system will generate a shared virtual object (such as a three-dimensional virtual object 426 shown in FIG. 4C) based on a view that the local user 102 selects from the interface 409 and/or multiple views 416.

FIG. 4C shows the local user 102 interacting with a three-dimensional virtual object 426. The computing system presents the three-dimensional virtual object 426 to the local user 102 with the orientation that the local user 102 selected with the interface 409 as described with respect to FIG. 4B. The three-dimensional virtual object 426 can have similar features as the three-dimensional virtual object 126. The computing system can present a semi-transparent sphere around the multiple views 416, enabling the local user 102 to move, grab, and/or resize the three-dimensional virtual object 426. The computing system will present the three-dimensional virtual object 426 to another user, such as the remote user 152, and/or receive input to the three-dimensional virtual object 426 from the remote user 152 and modify attributes of the three-dimensional virtual object 426 based on input from the remote user 152.

FIG. 4D shows a representation of the three-dimensional virtual object 456 and a representation of the user 452. The local user 102 interacts with the three-dimensional virtual object 426. In some implementations, the computing system presents the representation of the user 452 and the representation of the three-dimensional virtual object 456 to the local user 102 such as within a mini-screen of the display of the local computing device 104. In some implementations, the computing system presents the representation of the user 452 and the representation of the three-dimensional virtual object 456 to the remote user 152 via a display included in the remote computing device 154.

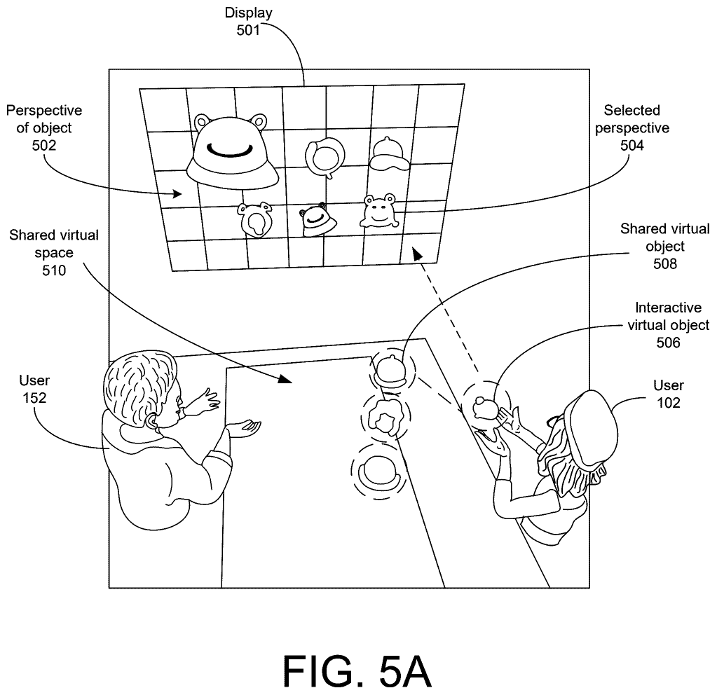

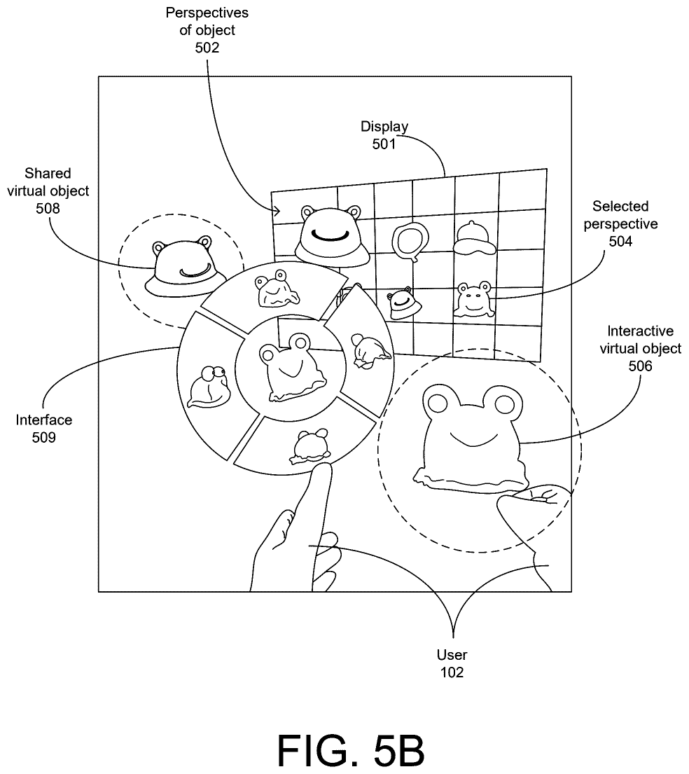

FIGS. 5A and 5B show a third-person perspective and a first-person perspective of perspectives of an object 502 and an interactive version of the object 506. The third-person perspective shown in FIG. 5A shows the local user 102 and remote user 152 interacting within a virtual environment that includes the virtual space 110.

A display 501 presents multiple perspectives of an object 502. The display 501 can be an image presented to both the local user 102 and the remote user 152 by the computing system via the local computing device 104 and remote computing device 154. The object can be the three-dimensional virtual object 126 that was generated as described above with respect to the three-dimensional virtual object 126. The computing system can generate and present the multiple perspectives of the object 502 to the local user 102. The local user 102 can select one of the multiple perspectives of the object 502 as a selected perspective 504. The local user 102 can select the selected perspective 504 via an interface 509. The interface 509 can be a pie menu with similar features as the pie menu version of the interface 409 described with respect to FIG. 4B. In the example shown in FIG. 5B, the local user 102 can rotate the interface 509 to select the selected perspective. In the example shown in FIG. 5B, the local user 102 can control and/or provide input to the interface 509 by gesture input captured by a camera included in the computing system.

The computing system can generate an interactive virtual object 506 with a perspective toward the local user 102 that corresponds to the perspective of the selected perspective 504. The local user 102 can interact with the interactive virtual object 506 in a similar manner to the three-dimensional virtual object 126 described above. The computing system can present, to the remote user 152 within a shared virtual space 510, a shared virtual object 508 corresponding to the interactive virtual object. The shared virtual space 510 can have similar features and/or properties as the virtual space 110. The computing system can change attributes of the shared virtual object 508, such as location and/or orientation, in response to input to the interactive virtual object 506 from the local user 102.

In some implementations, the computing system responds to selection of a perspective by the local user 102 via the interface 509 by presenting an object with the selected perspective on the display 501. The local user 102 and remote user 152 can view the object on the display 501.

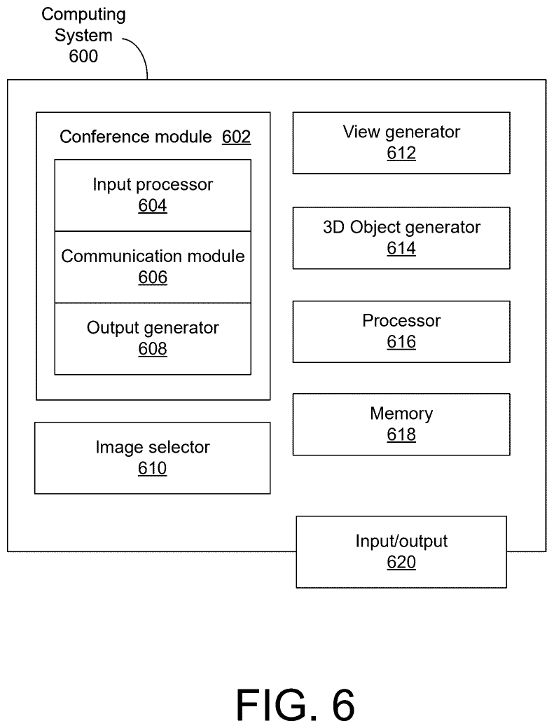

FIG. 6 is a block diagram of a computing system 600. The computing system 600 is an example of the computing system described above. The computing system 600 can include the local computing device 104, a computing device in communication with the local computing device 104 (such as a server), or a combination of the local computing device 104 and one or more computing devices in communication with the local computing device 104.

The computing system 600 can include a conference module 602. The conference module 602 can set up, maintain, and/or facilitate a video session between two or more users interacting with computing devices, such as between the local user 102 and the remote user 152 via the local computing device 104 and the remote computing device 154. The conference module 602 can facilitate the video session on a dedicated video application, or a web-based platform. The users can join a video session via a shared link or a calendar invitation. Upon joining, the users enter a shared digital space. The shared digital space can be a grid of video feeds and a user interface for managing tools. Live images can be presented of each user, or users can be represented by customizable avatars within a shared three-dimensional environment, which can be a virtual office, conference room, or a more abstract space. The shared digital space can be equipped with collaborative tools, such as communication channels, content sharing, and/or collaborative surface. Communication channels can include real-time audio and video streaming, along with a text-based chat for side conversations and sharing links. Content sharing can include the ability to share a local display, a specific application window, or individual files. Collaborative surfaces can include digital whiteboards for freeform drawing and brainstorming, and sometimes shared documents or notes that can be edited in real-time by multiple participants.

The conference module 602 can include an input processor 604. The input processor 604 can receive and/or process input from users and/or the physical environment of the users. The input processor 604 can receive input from users via human interface devices such as keyboard and mouse input, touch input to a device such as a touchscreen, voice input processed and/or received by a microphone, gesture input captured by a camera, or controller input received by a controller that may include an inertial measurement unit (IMU) indicating orientation and/or direction and/or one or more buttons. The input processor 604 can also receive input from the surrounding environment via one or more cameras and/or one or more microphones.

The conference module 602 can include a communication module 606. The communication module 606 can facilitate communication between computing devices, such as between the local computing device 104 and the remote computing device 154, during the video session. The computing devices can communicate via a shared communication protocol, such as Hypertext Transfer Protocol (HTTP). The computing devices can exchange information about the users' physical movements, such as hand positions, orientation, and/or gesture, voice data based on audio data captured and/or processed by the input processor 604, and/or interaction data such as movement, location, and/or orientation of a virtual object such as the three-dimensional virtual object 126.

The conference module 602 can include an output generator 608. The output generator 608 can generate output for presentation to a local user, such as the local computing device 104 presenting audio data and video data to the local user 102. The output generator 608 can, for example, present video data of the remote user 152 or an avatar representing the remote user 152, an object such as the three-dimensional virtual object 126 or any other objects within a shared virtual space, and audio data such as voice data indicative of speech by the remote user 152.

The computing system 600 can include an image selector 610. The image selector 610 can select a two-dimensional image, such as the two-dimensional image 106, based on digital content such as images displayed within the video session or based on content of the physical environment captured by a camera. The image selector 610 can select the image based on input from the user, such as voice or text input, gesture input to create a sketch, or a selection of an image by the user.

In some implementations, a user can request to select an image from previously-selected images. The computing system 600 can respond to the request to select the image from previously-selected images by presenting two-dimensional images that the computing system 600 previously used to generate three-dimensional virtual objects. The user can select one of the presented two-dimensional images, and the computing system 600 can generate a three-dimensional virtual object based on the selected two-dimensional image. Two-dimensional images can subsequently be used to generate three-dimensional virtual objects in different virtual environments and/or for different users.

In some implementations, the user can request modifications to a two-dimensional image before the image is selected for generation of the three-dimensional virtual object. In some implementations, the computing system 600 implements requested changes to the image heuristically, such as by changing a color, size, or dimension of the image. In some implementations, the computing system 600 implements requested changes to the image by applying a generative model.

The computing system 600 can include a view generator 612. The view generator 612 can generate views, such as the multiple views 116, based on the image selected by the image selector 610. The view generator 612 can generate new perspectives of the object that is the subject of the image selected by the image selector 610. The image selected by the image selector 610 can act as a condition or a strong prompt for a generative model. The generative model can infer and render what the object would look like from different, unseen angles. In some implementations, the view generator 612 generates four orthogonal views, such as a front view, a back view, and two side views (e.g. a right view and a left view). The views can be represented as point clouds.

The computing system 600 can include a three-dimensional object generator 614. The three-dimensional object generator 614 can generate a three-dimensional object, such as the three-dimensional virtual object 126, based on the views generated by the view generator 612. The three-dimensional object generator 614 can apply a Gaussian model to fuse the views into a cohesive three-dimensional representation. The three-dimensional representation can include a Gaussian splat with a point cloud. An example of the three-dimensional representation is the three-dimensional virtual object 126.

The computing system 600 can include at least one processor 616. The at least one processor 616 can execute instructions, such as instructions stored in at least one memory device 618, to cause the computing system 600 to perform any combination of methods, functions, and/or techniques described herein.

The computing system 600 can include at least one memory device 618. The at least one memory device 618 can include a non-transitory computer-readable storage medium. The at least one memory device 618 can store data and instructions thereon that, when executed by at least one processor, such as the processor 616, are configured to cause the computing system 600 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 600 can be configured to perform, alone, or in combination with computing system 600, any combination of methods, functions, and/or techniques described herein.

The computing system 600 can include at least one input/output node 620. The at least one input/output node 620 may receive and/or send data, such as from and/or to, a server or a computing device on which a browser is executing, and/or may receive input and provide output from and to a user. The input and output functions may be combined into a single node, or may be divided into separate input and output nodes. The input/output node 620 can include, for example, a microphone, a camera, a display, a speaker, one or more buttons and/or an HID, and/or one or more wired or wireless interfaces for communicating with computing devices.

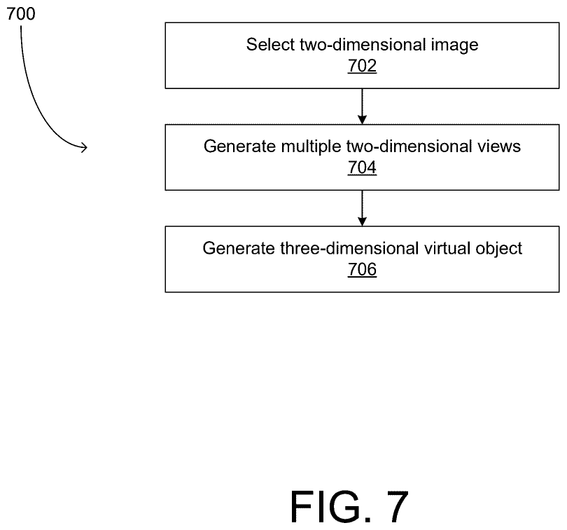

FIG. 7 is a flowchart of a method 700 performed by the computing system 600. The method 700 comprises selecting a two-dimensional image based on input to a computing device (702), generating multiple two-dimensional views of an object based on the two-dimensional image (704), and generating a three-dimensional virtual object based on the multiple two-dimensional views (706).

In some implementations, the method 700 further includes sharing the three-dimensional virtual object in a video session between the computing device and at least one other computing device, and enabling interaction with the three-dimensional virtual object by the computing device and the at least one other computing device.

In some implementations, generating the three-dimensional virtual object includes generating sparse point clouds based on the multiple two-dimensional views, and generating the three-dimensional virtual object based on the sparse point clouds.

In some implementations, the multiple two-dimensional views of the object are represented as point clouds.

In some implementations, generating the three-dimensional virtual object based on the multiple two-dimensional views includes performing Gaussian splatting based on the multiple two-dimensional views.

In some implementations, the multiple two-dimensional views of the object are orthogonal to each other.

In some implementations, the input includes text input and selecting the two-dimensional image includes performing an image search based on the text input and selecting the two-dimensional image from results of the image search.

In some implementations, the two-dimensional image was captured by a camera in communication with the computing device, and the input was a selection of the two-dimensional image.

In some implementations, the input includes hand movement.

In some implementations, the method 700 further includes receiving movement input associated with the three-dimensional virtual object, and sending, to a remote computing device, movement data associated with the three-dimensional virtual object.

In some implementations, the computing device is a local computing device, the input is received during a video session, and the method 700 further includes sending the three-dimensional virtual object to a remote computing device, the remote computing device being in communication with the local computing system during the video session.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the described implementations.

What is claimed is:

1. A method comprising:
selecting a two-dimensional image based on input to a computing device;
generating multiple two-dimensional views of an object based on the two-dimensional image; and
generating a three-dimensional virtual object based on the multiple two-dimensional views.

2. The method of claim 1, further comprising:
sharing the three-dimensional virtual object in a video session between the computing device and at least one other computing device; and
enabling interaction with the three-dimensional virtual object by the computing device and the at least one other computing device.

3. The method of claim 1, wherein generating the three-dimensional virtual object includes:
generating sparse point clouds based on the multiple two-dimensional views; and
generating the three-dimensional virtual object based on the sparse point clouds.

4. The method of claim 1, wherein the multiple two-dimensional views of the object are represented as point clouds.

5. The method of claim 1, wherein generating the three-dimensional virtual object based on the multiple two-dimensional views includes performing Gaussian splatting based on the multiple two-dimensional views.

6. The method of claim 1, wherein the multiple two-dimensional views of the object are orthogonal to each other.

7. The method of claim 1, wherein:
the input includes text input; and
selecting the two-dimensional image includes:
performing an image search based on the text input; and
selecting the two-dimensional image from results of the image search.

8. The method of claim 1, wherein:
the two-dimensional image was captured by a camera in communication with the computing device; and
the input was a selection of the two-dimensional image.

9. The method of claim 1, wherein the input includes hand movement.

10. The method of claim 1, further comprising:
receiving movement input associated with the three-dimensional virtual object; and
sending, to a remote computing device, movement data associated with the three-dimensional virtual object.

11. The method of claim 1, wherein:
the computing device is a local computing device,
the input is received during a video session, and
the method further includes sending the three-dimensional virtual object to a remote computing device, the remote computing device being in communication with the local computing device during the video session.

12. A non-transitory computer-readable storage medium comprising instructions stored thereon that, when executed by at least one processor, are configured to cause a computing system to:
select a two-dimensional image based on input to a computing device;
generate multiple two-dimensional views of an object based on the two-dimensional image; and
generate a three-dimensional virtual object based on the multiple two-dimensional views.

13. The non-transitory computer-readable storage medium of claim 12, wherein the instructions are further configured to cause the computing system to:
share the three-dimensional virtual object in a video session between the computing device and at least one other computing device; and
enable interaction with the three-dimensional virtual object by the computing device and the at least one other computing device.

14. The non-transitory computer-readable storage medium of claim 12, wherein generating the three-dimensional virtual object includes:
generating sparse point clouds based on the multiple two-dimensional views; and
generating the three-dimensional virtual object based on the sparse point clouds.

15. The non-transitory computer-readable storage medium of claim 12, wherein the multiple two-dimensional views of the object are represented as point clouds.

16. The non-transitory computer-readable storage medium of claim 12, wherein generating the three-dimensional virtual object based on the multiple two-dimensional views includes performing Gaussian splatting based on the multiple two-dimensional views.

17. The non-transitory computer-readable storage medium of claim 12, wherein the multiple two-dimensional views of the object are orthogonal to each other.

18. A computing system comprising:
at least one processor; and
a non-transitory computer-readable storage medium comprising instructions stored thereon that, when executed by the at least one processor, are configured to cause the computing system to:
select a two-dimensional image based on input to a local computing device;
generate multiple two-dimensional views of an object based on the two-dimensional image; and
generate a three-dimensional virtual object based on the multiple two-dimensional views.

19. The computing system of claim 18, wherein the instructions are further configured to cause the computing system to:
share the three-dimensional virtual object in a video session between the computing system and at least one computing device; and
enable interaction with the three-dimensional virtual object by the computing system and the at least one computing device.

20. The computing system of claim 18, wherein generating the three-dimensional virtual object includes:
generating sparse point clouds based on the multiple two-dimensional views; and
generating the three-dimensional virtual object based on the sparse point clouds.

21. The computing system of claim 18, wherein the multiple two-dimensional views of the object are represented as point clouds.

22. The computing system of claim 18, wherein generating the three-dimensional virtual object based on the multiple two-dimensional views includes performing Gaussian splatting based on the multiple two-dimensional views.

23. The computing system of claim 18, wherein the multiple two-dimensional views of the object are orthogonal to each other.
